(19) United States
(12) Patent Application Publication
(10) Pub. No.: US 2013/0206752 A1
(43) Pub. Date: Aug. 15, 2013

(54) COOKING APPARATUS

(71) Applicants: Hyun Wook Moon, Geumchun-ku (KR); Jae Kyung Yang, Geumchun-ku (KR); Sung Hun Sim, Geumchun-ku (KR); Heung Sik Choi, Geumchun-ku (KR); Wan Soo Kim, Geumchun-ku (KR); Ri Na Hwang, Geumchun-ku (KR)

(72) Inventors: Hyun Wook Moon, Geumchun-ku (KR); Jae Kyung Yang, Geumchun-ku (KR); Sung Hun Sim, Geumchun-ku (KR); Heung Sik Choi, Geumchun-ku (KR); Wan Soo Kim, Geumchun-ku (KR); Ri Na Hwang, Geumchun-ku (KR)

(21) Appl. No.: 13/699,816

(22) PCT Filed: May 26, 2011
(86) PCT No.: PCT/KR2011/003849

§ 371 Date: Apr. 22, 2013

(30) Foreign Application Priority Data
May 26, 2010 (KR) 10-2010-0049255
May 26, 2010 (KR) 10-2010-0049256
Dec. 23, 2010 (KR) 10-2010-0133740

(51) Int. Cl. H05B 6/64

(52) U.S. Cl. CPC H05B 6/64
USPC 219/745

(57) ABSTRACT

Provided herein are a cooking apparatus and an operating method thereof. The cooking apparatus includes a microwave generator to generate and output microwaves of a plurality of frequencies to heat an object within a cavity, a resonance mode conversion unit to convert a resonance mode by varying at least one of progressing direction, power or frequency of the microwaves output to the inside of the cavity, and a controller to operate the resonance mode conversion unit, if the number of frequencies of microwaves, the heating efficiencies of which are more than a reference heating efficiency, is below a reference value, based on heating efficiencies calculated according to microwaves reflected by the inside of the cavity from among the output microwaves. Thereby, operating efficiency of the cooking apparatus is improved.

### TECHNICAL FIELD

The present invention relates to a cooking apparatus and an operating method thereof, and more particularly to a cooking apparatus, operating efficiency of which is improved, and an operating method thereof.

### BACKGROUND ART

In general, in a cooking apparatus using microwaves, when an operation button is pressed after food is put into a cavity and then the cavity is sealed, voltage is applied to a high-voltage transformer, the commercial voltage applied to the high-voltage transformer is boosted to high-voltage power, the power is applied to a magnetron to generate microwaves and the microwaves generated by the magnetron are transmitted to the cavity through a waveguide, etc.

Here, the cooking apparatus using microwaves heats the food using frictional force generated by vibration of molecules of the food 2,450,000,000 times per second due to irradiation of the microwaves generated by the magnetron onto the food.

Such a cooking apparatus using microwaves has advantages, such as ease of temperature control, cooking time saving, convenience in operation, etc., and thus has been broadly distributed in many households.

However, if food is cooked using microwaves, the food is not uniformly heated due to surface variation of the food and a partial temperature difference of the food may occur. Further, temperature variation during cooking may occur according to kinds of food accommodated in the cooking apparatus.

### DISCLOSURE OF INVENTION

### Technical Problem

Therefore, the present invention has been made in view of the above problems, and it is an object of the present invention to provide a cooking apparatus, operating efficiency of which is improved, and an operating method thereof.

Another object of the present invention is to provide a cooking apparatus which uniformly heats a load using a field adjustment element and a switch.

### Solution to Problem

To achieve the above objects, there is provided a cooking apparatus according to an exemplary embodiment of the present invention, including a microwave generator to generate and output microwaves of a plurality of frequencies to heat an object within a cavity, a resonance mode conversion unit to convert a resonance mode by varying at least one of progressing direction, power or frequency of the microwaves output to the inside of the cavity, and a controller to operate the resonance mode conversion unit, if the number of frequencies of microwaves, the heating efficiencies of which are more than a reference heating efficiency, is below a reference value, based on heating efficiencies calculated according to microwaves reflected by the inside of the cavity from among the output microwaves.

To achieve the above objects, there is provided a cooking apparatus according to an exemplary embodiment of the present invention, including a microwave generator to generate and output microwaves of a single frequency to heat an object within a cavity, a resonance mode conversion unit to convert a resonance mode by varying at least one of progressing direction, power or frequency of the microwaves output to the inside of the cavity, and a controller to calculate heating efficiencies according to microwaves reflected by the inside of the cavity from among the output microwaves during operation of the resonance mode conversion unit, to calculate the maximum heating efficiency based on the calculated heating efficiencies after operation of the resonance mode conversion unit has been completed, and to perform a heating session according to an operation state of the resonance mode conversion unit corresponding to the calculated maximum heating efficiency.

To achieve the above objects, there is provided a cooking apparatus according to an exemplary embodiment of the present invention, including a microwave generator to generate and output microwaves of a single frequency to heat an object within a cavity, a resonance mode conversion unit to convert a resonance mode by varying at least one of progressing direction, power or frequency of the microwaves output to the inside of the cavity, and a controller to calculate heating efficiencies according to microwaves reflected by the inside of the cavity during operation of the resonance mode conversion unit, and to stop operation of the resonance mode conversion unit and to perform a heating session, if the calculated heating efficiency is more than a reference heating efficiency.

To achieve the above objects, there is provided a cooking apparatus according to an exemplary embodiment of the present invention, including a cavity, a microwave generator to generate and output microwaves to the inside of the cavity, a field adjustment unit to adjust frequencies of the microwaves output from the microwave generator, an antenna unit located within the cavity to irradiate the microwaves output from the microwave generator to the inside of the cavity, and a switch unit to separate transmission paths of the microwaves output from the microwave generator, wherein the microwave generator includes a microwave controller to control the field adjustment unit and the switch unit so as to adjust the frequencies, and a power unit to supply drive power of the microwaves.

### Advantageous Effects of Invention

As apparent from the above description, a cooking apparatus using microwaves in accordance with one embodiment of the present invention, during a scanning session, calculates heating efficiencies based on reflected microwaves, and operates a resonance mode conversion unit, if the number of frequencies of microwaves, the heating efficiencies of which are more than a reference heating efficiency, is below a reference value, based on the calculated heating efficiencies. Thereby, a resonance mode in a cavity is converted, and thus, the cooking apparatus may effectively enter a heating session. By operating the resonance mode conversion unit, the scanning session is not continuously repeated and the heating session is performed, thereby effectively performing heating.

If the number of frequencies of microwaves, the heating efficiencies of which are more than the reference heating efficiency, is below the reference value even through operation of resonance mode conversion unit, the reference heating efficiency is lowered. The scanning session is not continuously repeated and the heating session may be performed through lowering of the reference efficiency, thereby effectively performing heating.

When the heating session is performed and then the scanning session is performed again according to the lowered reference heating efficiency, if the number of frequencies of microwaves, the heating efficiencies of which are more than the lowered reference heating efficiency based on the calculated heating efficiencies according to frequencies, is more than the reference value, the reference heating efficiency is raised again. Thus, the heating session is not continuously repeated through the raised heating efficiency, thereby uniformly heating an object to be cooked.

A cooking apparatus using microwaves in accordance with another embodiment of the present invention calculates heating efficiencies based on reflected microwaves while operating a resonance mode conversion unit under the condition that microwaves of a single frequency are generated and output, and enters a heating session based on the calculated heating efficiencies, thereby effectively entering the heating session.

Particularly, the cooking apparatus enters the heating session according to the maximum heating efficiency after periodic operation of the resonance mode conversion unit has been completed, thereby effectively performing heating.

Further, if the calculated heating efficiency is more than a reference ratio during operation of the resonance mode conversion unit, the cooking apparatus immediately enters the heating session, thereby effectively performing heating.

A cooking apparatus using microwaves in accordance with a further embodiment of the present invention heats an object to be cooked using microwaves having frequencies, heating efficiencies of which are more than a reference heating efficiency, thereby more uniformly heating the object, reducing energy consumption and shortening heating time.

Further, the cooking apparatus allows a resonance mode to be formed using a field adjustment element and reduces vertical temperature variation in heating within a cavity, thus uniformly heating the object to be cooked.

Further, the cooking apparatus allows microwaves to be radiated through a plurality of antennas using a switch unit, thereby uniformly heating the object and improving energy efficiency.

### BRIEF DESCRIPTION OF DRAWINGS

The above and other objects, features and other advantages of the present invention will be more clearly understood from the following detailed description taken in conjunction with the accompanying drawings, in which:

FIG. 1 is a partial perspective view of a cooking apparatus in accordance with one embodiment of the present invention;

FIG. 2 is a cross-sectional view of the cooking apparatus of FIG. 1;

FIG. 3 is a block diagram briefly illustrating the inside of the cooking apparatus of FIG. 1;

FIG. 4 is a flow chart illustrating an operating method of a cooking apparatus using microwaves in accordance with one embodiment of the present invention;

FIGS. 5 to 9 are reference views illustrating the operating method of the cooking apparatus of FIG. 4;

FIG. 10 is a flow chart illustrating an operating method of a cooking apparatus using microwaves in accordance with another embodiment of the present invention;

FIGS. 11 to 13 are reference views illustrating the operating method of the cooking apparatus of FIG. 10;

FIG. 14 is a block diagram briefly illustrating one example of the inside of the cooking apparatus of FIG. 1;

FIG. 15 is a block diagram briefly illustrating another example of the inside of the cooking apparatus of FIG. 1;

FIG. 16 is a circuit diagram briefly illustrating the inside of a solid state power oscillator of FIG. 15;

FIG. 17 is a block diagram illustrating a configuration of a cooking apparatus in accordance with another embodiment of the present invention;

FIG. 18 is a flow chart illustrating an operating method of the cooking apparatus in accordance with the embodiment of the present invention;

FIG. 19 is a flow chart illustrating a process of calculating heating efficiencies; and

FIG. 20 is a flow chart illustrating operation of a switch unit in the cooking apparatus in accordance with the embodiment of present invention.

### BEST MODE FOR CARRYING OUT THE INVENTION

The advantages and features of the present invention, and the way of attaining them, will become apparent with reference to embodiments described below in conjunction with the accompanying drawings.

Hereinafter, it will be understood that suffixes “module”, “unit”, and “part” applied to elements used in the following description are used in consideration of ease of illustration and the suffixes themselves do not have discriminative meanings or roles. Therefore, the suffixes “module”, “unit”, and “part” may be used interchangeably.

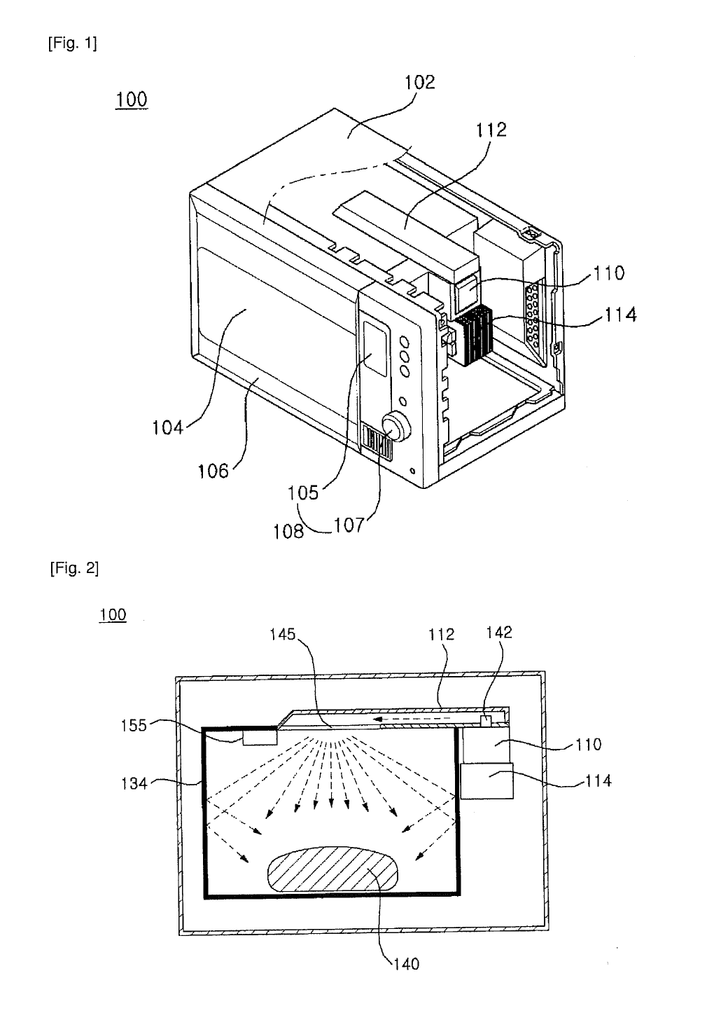

FIG. 1 is a partial perspective view of a cooking apparatus in accordance with one embodiment of the present invention, and FIG. 2 is a cross-sectional view of the cooking apparatus of FIG. 1.

With reference to FIGS. 1 and 2, a cooking apparatus 100 in accordance with the embodiment of the present invention is configured such that a door 106 provided with a cooking window 104 is connected to a front surface part of a main body 102 so as to be opened and closed and an operation panel 108 is connected to one side of the front surface of the main body 102.

The door 106 opens and closes a cavity 134, and a door choke (not shown) to intercept microwaves may be disposed on the inner surface of the door 106.

The operation panel 108 includes an input unit 107 to control operation of the cooking apparatus 100 and a display 105 to display the operating state of the cooking apparatus 100.

The cavity 134 having an accommodation space of a designated size is provided within the main body 102 such that an object to be heated, for example, food may be accommodated within the cavity 134 and be cooked by microwaves.

The cavity 134 is formed by bonding plates, each of which forms at least one surface, and has an approximately rectangular parallelepiped shape having an opened front surface.

A microwave generator 110 to generate microwaves is installed on the outer surface of the cavity 134, and a microwave transmission unit 112 to guide the microwaves generated by the microwave generator 112 to the inside of the cavity 134 is disposed at the output side of the microwave generator 110.

The microwave generator 110 may include a magnetron or a Solid State Power Amplifier (SSPA) using a semiconductor. The SSPA is advantageous in that the SSPA occupies less space than the magnetron.

The SSPA may be implemented as a Hybrid Microwave Integrated Circuit (HMIC) in which passive elements (capacitors, inductors, etc.) and active elements (transistors, etc.) for amplification are separately provided, or a Monolithic Microwave Integrated Circuit (MMIC) in which passive elements and active elements are integrated into one substrate.

The microwave generator 110 may be implemented as one module into which SSPAs are integrated, and may be referred to as a Solid State Power Module (SSPM).

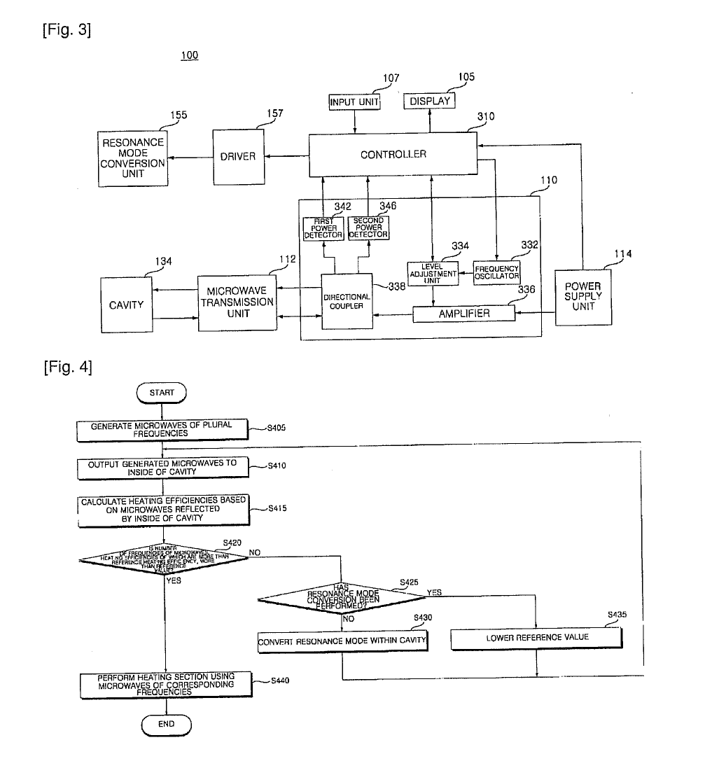

In accordance with the embodiment of the present invention, the microwave generator 110 may generate and output a plurality of microwaves of different frequencies. These frequencies of the microwaves may be in the range of approximately 900 MHz˜2,500 MHz. Particularly, the frequencies of the microwaves may be in a designated range around 915 MHz or in a designated range around 2,450 MHz. A detailed description of the microwave generator 110 will be described later with reference to FIG. 3 below.

The microwave transmission unit 112 transmits the microwaves generated by the microwave generator 110 to the cavity 134. Such a microwave transmission unit 112 may include a transmission line. The transmission line may be a waveguide or a coaxial cable. In order to deliver the generated microwaves to the microwave transmission unit 112, a feeder 142 is connected, as shown in FIG. 2.

The microwave transmission unit 112 may be provided as a shape with an opening 145 communicating with the inside of the cavity 134, as shown in FIG. 2. However, the microwave transmission unit 112 is not limited thereto and may be provided as a shape with an antenna connected to the end thereof. The opening 145 may have various shapes, such as a slot. The microwaves are discharged to the cavity 134 through the opening 145 or the antenna.

Although the drawings illustrate one opening 145 as being disposed at the upper portion of the cavity 134, the opening 145 may be disposed at the lower portion or the side portion of the cavity 134, or a plurality of openings may be disposed. Such a disposition may be applied to the shape of the microwave transmission unit 112 provided with the end to which the antenna is connected.

A power supply unit 114 to supply power to the microwave generator 110 is provided under the microwave generator 110.

The power supply unit 114 includes a high-voltage transformer to boost power input to the cooking apparatus 100 to high voltage and then to supply the high voltage to the microwave generator 110, or an inverter to supply high output voltage of more than approximately 3,500V, generated through switching operation of at least one switch element, to the microwave generator 110.

A cooling fan (not shown) to cool the microwave generator 110 may be installed around the microwave generator 110.

A resonance mode conversion unit 155 may be installed in the cavity 134. The resonance mode conversion unit 155 converts a resonance mode by varying at least one of progressing direction, power or frequency of microwaves output to the inside of the cavity 134.

Although FIG. 2 illustrates the resonance mode conversion unit 155 as being disposed around the opening 145, the position of the resonance mode conversion unit 155 is not limited thereto. That is, the resonance mode conversion unit 155 may be disposed under an object 140 to be heated or disposed on the side surface of the cavity 134.

For example, the resonance mode conversion unit (not shown) may include at least one of a stirrer, a rotating table and a sliding table. Among these, the rotating table and the sliding table may be disposed at the lower portion of the cavity 134, and the stirrer may be disposed at various positions, i.e., the lower portion, the side surface and the upper portion of the cavity 134.

Hereinafter, as the resonance mode conversion unit 155 shown in FIG. 2, a stirrer, particularly disposed around the opening 145, will be described.

In the above-described cooking apparatus 100, after a user opens the door 106 and puts the object 140 to be heated into the cavity 134, when the user closes the door 106, or closes the door 106 and operates the operation panel 108, particularly the input unit 107, and then presses a start button (not shown), the cooking apparatus 100 is operated.

That is, the power supply unit 114 in the cooking apparatus 100 boosts input AC power to high-voltage DC power and then supplies the high-voltage DC power to the microwave generator 110, the microwave generator 110 generates and outputs corresponding microwaves, and the microwave transmission unit 112 transmits the generated microwaves so as to discharge the microwaves to the inside of the cavity 134. Thereby, the object 140 to be heated, for example, food located within the cavity 134, is heated.

FIG. 3 is a block diagram briefly illustrating the inside of the cooking apparatus of FIG. 1.

With reference to FIG. 3, the cooking apparatus 100 in accordance with the embodiment of the present invention includes the microwave generator 110, the microwave transmission unit 112, the cavity 134, the resonance mode conversion unit 155, a driver 157 and a controller 310.

The microwave generator 110 includes a frequency oscillator 332, a level adjustment unit 334, an amplifier 336, a directional coupler 338, a first power detector 342 and a second power detector 346.

The frequency oscillator 332 oscillates and outputs microwaves of a corresponding frequency by a frequency control signal from the controller 310. The frequency oscillator 332 may include a Voltage Controlled Oscillator (VCO). The VCO oscillates the corresponding frequency according to a voltage level of the frequency control signal. For example, as the voltage level of the frequency control signal is higher, the frequency oscillated and generated by the VCO is higher.

The level adjustment unit 334 oscillates and outputs the microwaves, having been oscillated and output by the frequency signal of the frequency oscillator 332, with corresponding power according to a power control signal. The level adjustment unit 334 may include a Voltage Controlled Attenuator (VCA).

The VCA performs a compensation operation so as to output the microwaves with corresponding power according to the voltage level of the power control signal. For example, as the voltage level of the power control signal is higher, the power level of the signal output from the VCA is higher.

The amplifier 336 amplifies, based on the frequency signal oscillated by the frequency oscillator 332 and the power control signal generated by the level adjustment unit 334, the oscillated frequency signal and then outputs microwaves.

The amplifier 336 may be provided with the SSPA using a semiconductor, as described above, and particularly provided with the MMIC using one substrate. Thereby, the amplifier 336 has a small size, thus achieving element integration.

On the other hand, the above-described frequency oscillator 332, level adjustment unit 334 and the amplifier 336 may be integrated into one assembly, and such an assembly may be referred to as a Solid State Power Oscillator (SSPO).

The Directional Coupler (DC) 338 transmits the microwaves amplified and output from the amplifier 336 to the microwave transmission unit 112. The microwaves output from the microwave transmission unit 112 heat the object in the cavity 134.

Microwaves, which are not absorbed by the object in the cavity 134, instead being reflected by the object, may be input to the DC 338 through the microwave transmission unit 112. The DC 338 transmits the reflected microwaves to the controller 310.

The first power detector 342 is disposed between the DC 338 and the controller 310 and detects output power of microwaves amplified by the amplifier 336 and transmitted to the microwave transmission unit 112 via the DC 338. The detected power signal is input to the controller 310 and is used in heating efficiency calculation. The first power detector 342 may include a diode element, etc. to detect power.

On the other hand, the second power detector 346 is disposed between the DC 338 and the controller 310 and detects power of microwaves reflected by the inside of the cavity 134 and received by the DC 338. The detected power signal is input to the controller 310 and is used in heating efficiency calculation. The second power detector 346 may include a diode element, etc. to detect power.

The microwave generator 110 may further include an isolation unit (not shown) which is disposed between the amplifier 336 and the DC 338, passes microwaves amplified by the amplifier 336 if the amplified microwaves are transmitted to the cavity 134, and intercepts microwaves reflected by the inside of the cavity 134. The isolation unit (not shown) may include an isolator.

The controller 310 calculates heating efficiencies based on microwaves, which are not absorbed by the object, instead being reflected by the object, from among the microwaves discharged to the inside of the cavity 134.

$${h}_{e} = \frac{{P}_{t} - {P}_{r}}{{P}_{t}} \qquad [ Equation 1 ]$$

Here, Pₜ represents power of microwaves discharged to the inside of the cavity 134, Pᵣ represents power of microwaves reflected by the inside of the cavity 134, and hₑ represents heating efficiency of microwaves.

According to Equation 1 above, as the power of the reflected microwaves is higher, the heating efficiency hₑ is smaller.

If microwaves of a plurality of frequencies are discharged to the inside of the cavity 134, the controller 310 calculates heating efficiencies hₑ of the microwaves according to frequencies. Such heating efficiency calculation may be performed throughout the entire cooking session in accordance with the embodiment of the present invention.

In order to effectively achieve heating, the entire cooking session may be divided into a scanning session and a heating session. During the scanning session, the microwaves of the plurality of frequencies are sequentially discharged to the inside of the cavity 134, and heating efficiencies are calculated based on reflected microwaves. Further, during the heating session, the microwaves are output for different output times according to frequencies or only microwaves of a designated frequency are output, based on the heating efficiencies calculated during the scanning session. Preferably, power of the microwaves during the heating session is considerably greater than power of the microwaves during the scanning session.

The controller 310 generates and outputs a frequency control signal so as to vary the output times of the microwaves according to the calculated heating efficiencies. The frequency oscillator 332 oscillates a corresponding frequency according to the input frequency control signal.

The controller 310 generates the frequency control signal so that, if the calculated heating efficiency hₑ is high, the output time of the corresponding microwaves becomes short. That is, while the microwaves of the plurality of frequencies are sequentially swept, output times of the microwaves of the plurality of frequencies may be varied according to the calculated heating efficiencies. That is, as the heating efficiency hₑ, is higher, the corresponding output time is preferably shorter. Thereby, the microwaves may be uniformly absorbed by the object 140 to be heated within the cavity 134 according to frequencies, and thus uniformly heat the object 140.

On the other hand, the controller 310 may control the microwaves such that the microwaves of the corresponding frequencies are output, only if the calculated heating efficiencies hₑ according to the frequencies are more than a set value. That is, microwaves of frequencies having low heating efficiencies hₑ are excluded from an actual heating time, and thereby may effectively and uniformly heat the object 140.

The controller 310, the frequency oscillator 332, the level adjustment unit 334, the amplifier 336, the DC 338, the first power detector 342 and the second power detector 346 of the above-described microwave generator 110 may be integrated into one module. That is, these elements may be disposed on a single substrate so as to be integrated into one module.

The power supply unit 114 boosts power input to the cooking apparatus 100 to high voltage and then to supply the high voltage to the microwave generator 110. The power supply unit 114 may be implemented as a high-voltage transformer or an inverter.

The resonance mode conversion unit 155 is operated so as to convert a resonance mode by varying at least one of progressing direction, power or frequency of microwaves output to the inside of the cavity 134.

The resonance mode conversion unit 155 is operated by driving the driver 157 under the control of the controller 310. The driver 157 may include a motor (not shown) to drive rotating operation or reciprocating operation.

As described above, the resonance mode conversion unit 155 may include at least one of a stirrer, a rotating table and a sliding table. Hereinafter, as the resonance mode conversion unit 155, a stirrer will be described.

The controller 310 operates the resonance mode conversion unit 155, if the number of frequencies of microwaves, the heating efficiencies of which are more than reference heating efficiency based on heating efficiencies of the microwaves calculated according to frequencies for the scanning session, is below a reference value. For example, the controller 310 rotates the stirrer 155 disposed around the opening 145 by a first angle.

Thereafter, the scanning session is performed again, and then whether or not the number of frequencies of microwaves, the heating efficiencies of which are more than the reference heating efficiency based on the heating efficiencies of the microwaves calculated according to frequencies, is below the reference value is judged. Upon judging that the number of the frequencies of microwaves, the heating efficiencies of which are more than the reference heating efficiency, is below the reference value, the controller 310 rotates the stirrer 155 by a second angle greater than the first angle.

After periodic operation of the stirrer 155, i.e., one rotating operation of the stirrer has been completed, if the number of frequencies of microwaves, the heating efficiencies of which are more than the reference heating efficiency based on the heating efficiencies of the microwaves calculated according to frequencies, is below the reference value, the controller 310 lowers the reference heating efficiency. That is, the controller 310 lowers the reference heating efficiency so that the number of frequencies of microwaves, the heating efficiencies of which are more than the lowered reference heating efficiency, is more than the reference value. Thereby, the scanning session is not continuously repeated and the heating session may be performed, thereby efficiently performing heating.

Further, the controller 310 performs the heating session according to the lowered reference heating efficiency, and, when the scanning session is performed again, raises the reference heating efficiency, if the number of frequencies of microwaves, the heating efficiencies of which are more than the lowered reference heating efficiency based on the heating efficiencies of the microwaves calculated according to frequencies, is more than the reference value. Thereby, the heating session is not continuously repeated according to the lowered reference heating efficiency, and heating is effectively performed according to change of the object.

The block diagram of the cooking apparatus 100 shown in FIG. 3 is a block diagram in accordance with the embodiment of the present invention. The respective elements of the block diagrams may be integrated, added, or omitted according to specifications of the actually implemented cooking apparatus 100. That is, two or more elements may be combined into one element, or one element may be divided into two or more elements, as needed. Further, functions performed by respective blocks are provided to describe the embodiment of the present invention, and detailed operations or devices thereof do not limit the scope of the invention.

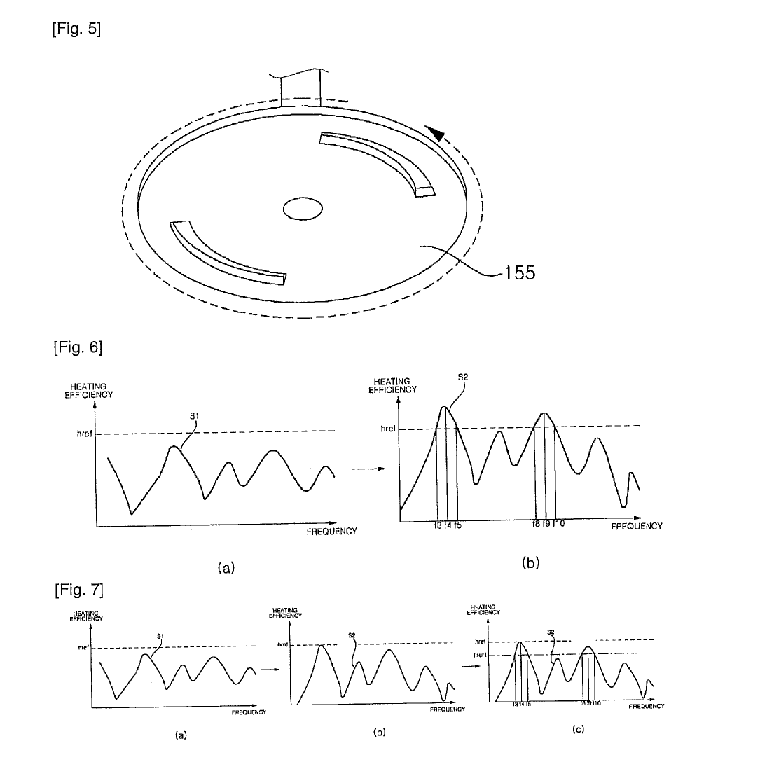

FIG. 4 is a flow chart illustrating an operating method of a cooking apparatus using microwaves in accordance with one embodiment of the present invention and FIGS. 5 to 9 are reference views illustrating the operating method of the cooking apparatus of FIG. 4.

With reference to FIG. 4, first, microwaves of a plurality of frequencies are generated (S405). The microwave generator 110 may sequentially generate microwaves having a plurality of different frequencies.

Thereafter, the generated microwaves are output to the inside of the cavity 134 (S410). The microwaves generated by the microwave generator 110 are output to the inside of the cavity 134 through the microwave transmission unit 112. Here, the microwaves of the plurality of frequencies may be sequentially output.

Thereafter, heating efficiencies are calculated based on microwaves reflected by the inside of the cavity 134 (S415). The controller 310 calculates the heating efficiencies using Equation 1 above, based on a power signal detected from the reflected microwaves received by the DC 338. Here, an output power signal of the microwaves output to the inside of the cavity 134 may be referred to.

Thereafter, whether or not the number of frequencies of microwaves, the heating efficiencies of which are more than reference heating efficiency based on the calculated heating efficiencies, is below a reference value is judged (S420). Upon judging that the number of frequencies of microwaves, the heating efficiencies of which are more than reference heating efficiency, is below the reference value, the controller 310 judges whether or not resonance mode conversion has been performed (S425), and converts the resonance mode in the cavity upon judging that the resonance mode conversion has not been performed (S430).

FIG. 6(a) exemplarily illustrates a heating efficiency curve S1 according to frequencies of microwaves during the scanning session. With reference to FIG. 6(a), it is understood that no frequency of microwaves have heating efficiencies more than the reference heating efficiency href. Thereby, the heating session, which is performed only if heating efficiency more than the reference heating efficiency is present, is not performed.

In the embodiment of the present invention, in order to prevent such a situation, resonance mode conversion in the cavity 134 is proposed. For this purpose, the resonance mode conversion unit 155 which varies at least one of progressing direction, power or frequency of microwaves is operated.

FIG. 5 illustrates one example of the stirrer 155. The stirrer 155 is configured so as to be rotated about its axis. Although FIG. 5 illustrates the disc-shaped stirrer 155, the stirrer 155 is not limited thereto but may have various shapes, such as a propeller shape. Further, the stirrer 155 may be implemented as a metal member so as to achieve resonance mode conversion.

As described above, for example, the stirrer 155 is rotated and thus varies progressing direction, power or/or frequency of microwaves output to the inside of the cavity 134, thereby converting the resonance mode in the cavity 134.

For example, the stirrer 155 is rotated by a first angle which is below 360 degrees. Thereafter, above step S410, S415 and S420 are performed again.

That is, after the stirrer 155 is rotated by the first angle, microwaves are output to the inside of the cavity 134, heating efficiencies are calculated based on microwaves reflected by the inside of the cavity from among the output microwaves, and whether or not the number of frequencies of microwaves, the heating efficiencies of which are more than reference heating efficiency, is below the reference value is judged.

FIG. 6(b) exemplarily illustrates a heating efficiency curve S2 according to frequencies of microwaves, caused by operation of the stirrer 155, during the scanning session. With reference to FIG. 6(b), it is understood that the heating efficiencies of the heating efficiency curve S2 caused by operation of the stirrer 155 are generally improved as compared to the heating efficiencies of the heating efficiency curve S1.

With reference to FIG. 6(b), it is understood that frequencies f3, f4, f5, f8, f9 and f10 from among the plurality of frequencies of microwaves have heating efficiencies more than the reference heating efficiency href and the number of the frequencies having heating efficiencies more than the reference heating efficiency href is more than the reference value (for example, 3). Thereby, microwaves of the calculated frequencies f3, f4, f5, f8, f9 and f10 are output with high power during the heating session (S440), thereby effectively performing heating.

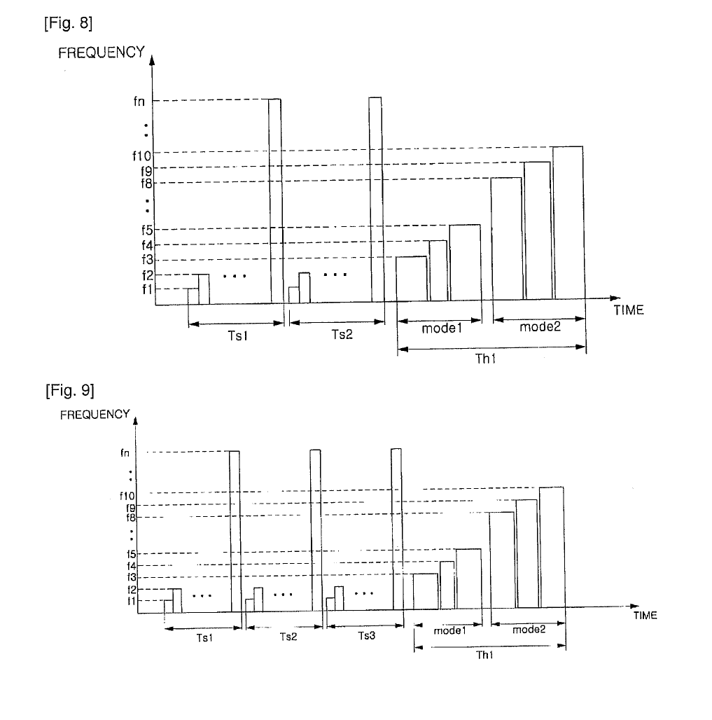

FIG. 8 illustrates operation of FIG. 6 applied to the entire cooking session.

During a first scanning session Ts1, heating efficiencies of microwaves of n frequencies are calculated. As described above, there may be no frequency of microwaves having heating efficiencies more than the reference heating efficiency href during the first scanning session Ts1, as shown in FIG. 6(a). Therefore, the resonance mode conversion unit 155, such as the stirrer, is operated, and thus a second scanning session Ts2 is performed.

During the second scanning session Ts2, heating efficiencies of microwaves of n frequencies are calculated. As described above, the number of frequencies of microwaves having heating efficiencies more than the reference heating efficiency href may be more than the reference value during the second scanning session Ts2, as shown in FIG. 6(b).

Thereby, during the heating session Th1, heating is performed based on the microwaves of the calculated frequencies f3, f4, f5, f8, f9 and f10. Here, the heating session Th1 is divided into a first heating mode mode1 and a second heating mode mode2 according to frequency concentration. In the first heating mode mode1, heating is performed using microwaves of the frequencies of f3, f4 and f5, and in the second heating mode mode2, heating is performed using microwaves of the frequencies of f8, f9 and f10.

Here, as heating efficiency increases, heating time may be shortened. Thereby, as shown in FIGS. 6 and 8, the heating time at the frequency f4 having the highest heating efficiency may be set to be shortest, and the heating time at the frequencies f3, f5, f8 and f10 having the lowest heating efficiency (i.e., the reference heating efficiency) may be set to be longest.

Upon judging that the number of the corresponding frequencies is below the reference value in step S420 and the resonance mode conversion has been performed in step S425, the controller 310 lowers the reference value (S435).

Lowering of the reference value may be performed just after one resonance mode conversion has been completed, and be preferably performed after the periodic operation of the stirrer 155 has been completed. That is, lowering of the reference value may be preferably performed after one rotating operation of the stirrer 155 has been completed. Before the one rotating operation of the stirrer 155 has been completed, the above-described output of microwaves and calculation of heating efficiencies may be continuously performed while rotating the stirrer 155 by the second angle, etc.

After lowering of the reference value, the above-described output of microwaves and calculation of heating efficiencies may be performed again. Further, whether or not the number of the frequencies of microwaves, the heating efficiencies of which are more than the lowered reference heating efficiency, is more than the reference value is judged (S420).

FIG. 7(b) exemplarily illustrates a heating efficiency curve S2 according to frequencies of microwaves, caused by operation of the stirrer 155, during the scanning session. With reference to FIG. 7(b), it is understood that the heating efficiencies of the heating efficiency curve S2 caused by operation of the stirrer 155 are generally improved as compared to the heating efficiencies of a heating efficiency curve S1 of FIG. 7(a). However, it is understood that no frequency of microwaves having heating efficiencies more than the reference heating efficiency href is present.

FIG. 7(c) illustrates lowered reference heating efficiency, compared to FIG. 7(b), and it is understood that the number of frequencies of microwaves, the heating efficiencies of which are more than the lowered reference heating efficiency, is more than a reference value. That is, it is understood that frequencies f3, f4, f5, f8, f9 and f10 from among the plurality of frequencies of microwaves have heating efficiencies more than the reference heating efficiency href and the number of the frequencies having heating efficiencies more than the reference heating efficiency href is more than the reference value (for example, 3). Thereby, microwaves of the calculated frequencies f3, f4, f5, f8, f9 and f10 are output with high power during the heating session (S440), thereby effectively performing heating.

FIG. 9 illustrates operation of FIG. 7 applied to the entire cooking session.

During a first scanning session Ts1, heating efficiencies of microwaves of n frequencies are calculated. As described above, there may be no frequency of microwaves having heating efficiencies more than the reference heating efficiency href during the first scanning session Ts1, as shown in FIG. 7(a). Therefore, the resonance mode conversion unit 155, such as the stirrer, is operated, and thus a second scanning session Ts2 is performed.

During the second scanning session Ts2, heating efficiencies of microwaves of n frequencies are calculated. As described above, there may be no frequency of microwaves having heating efficiencies more than the reference heating efficiency href in spite of operation of the stirrer 155 during the second scanning session Ts2, as shown in FIG. 7(b). Therefore, the reference heating efficiency is lowered, and thus a third scanning session Ts3 is performed.

During the third scanning session Ts3, heating efficiencies of microwaves of n frequencies are calculated. As described above, the number of frequencies of microwaves having heating efficiencies more than the reference heating efficiency href may be more than the reference value during the third scanning session Ts3, as shown in FIG. 7(c).

Thereby, during the heating session Th1, heating is performed based on the microwaves of the calculated frequencies f3, f4, f5, f8, f9 and f10. Here, the heating session Th1 is divided into a first heating mode mode1 and a second heating mode mode2 according to frequency concentration. In the first heating mode mode1, heating is performed using microwaves of the frequencies of f3, f4 and f5, and in the second heating mode mode2, heating is performed using microwaves of the frequencies of f8, f9 and f10.

Here, as heating efficiency increases, heating time may be shortened. Thereby, as shown in FIGS. 7 and 9, the heating time at the frequency f4 having the highest heating efficiency may be set to be shortest, and the heating time at the frequencies f3, f5, f8 and f10 having the lowest heating efficiency (i.e., the reference heating efficiency) may be set to be longest.

When the scanning session is performed again after lowering of the reference value, if the number of frequencies of microwaves, the heating efficiencies of which are more than the lowered reference heating efficiency, is more than the reference value, the lowered reference heating efficiency may be raised. Because performance of the heating session using the original reference heating efficiency is more suitable for uniform heating than performance of the heating session using the lowered reference heating efficiency.

Upon judging that the number of frequencies of microwaves, the heating efficiencies of which are more than the lowered reference heating efficiency, is more than the reference value in step S420 before resonance mode conversion has not been performed, the heating session is performed using microwaves of the corresponding frequencies (S440). Here, power of the microwaves during the heating session may be greater than power of the microwaves during the scanning session.

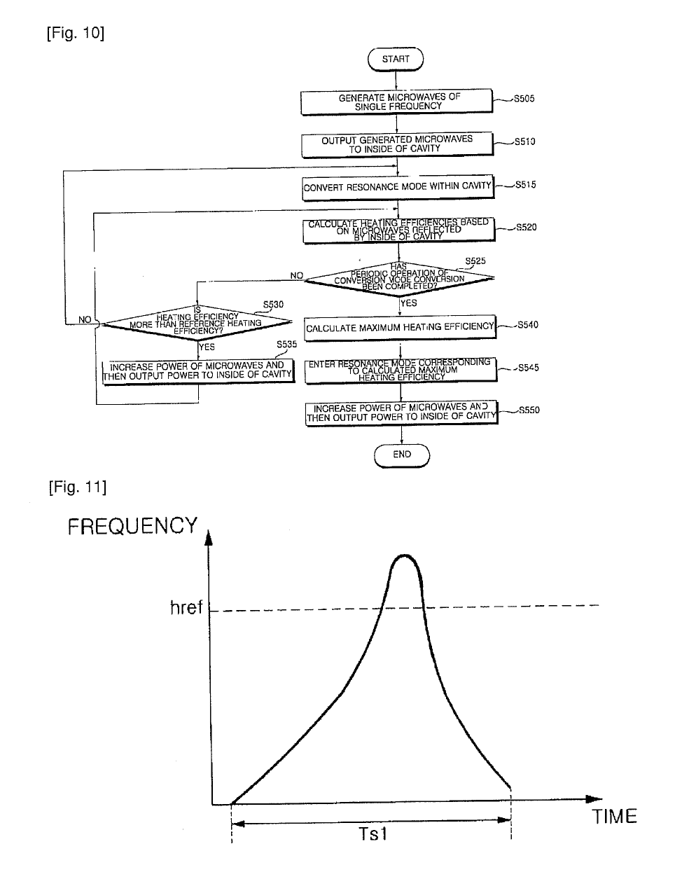

FIG. 10 is a flow chart illustrating an operating method of a cooking apparatus using microwaves in accordance with another embodiment of the present invention. FIGS. 11 to 13 are reference views illustrating the operating method of the cooking apparatus of FIG. 10.

With reference to FIG. 10, first, microwaves of a single frequency are generated (S505). The microwave generator 110 may generate microwaves having a designated frequency.

Thereafter, the generated microwaves are output to the inside of the cavity 134 (S510). The microwaves generated by the microwave generator 110 are output to the inside of the cavity 134 through the microwave transmission unit 112.

Thereafter, a resonance mode in the cavity 134 us converted (S515). This embodiment of the present invention is characterized in that microwaves of a single frequency are generated and output and resonance mode conversion unit 155 to convert the resonance mode in the cavity 134 by compensating for the microwaves of the single frequency is operated so as to uniformly heat an object. Such a resonance mode conversion unit 155 preferably varies at least one of progressing direction, power or frequency of the microwaves. As described above, the resonance mode conversion unit 155 may include at least one of a stiffer, a rotating table and a sliding table.

As described in FIG. 5, the resonance mode conversion unit 155 may be a stirrer. Hereinafter, as the resonance mode conversion unit 155, a stirrer will be described.

As described, for example, the stirrer 155 is rotated and thus varies progressing direction, power or frequency of the microwaves output to the inside of the cavity 134, thereby converting the resonance mode in the cavity 134.

Thereafter, heating efficiencies are calculated based on microwaves reflected by the inside of the cavity 134 (S520). The controller 310 calculates the heating efficiencies using Equation 1 above, based on a power signal detected from the reflected microwaves received by the DC 338. Here, an output power signal of the microwaves output to the inside of the cavity 134 may be referred to.

Here, heating efficiencies may be calculated according to rotating angles of the stirrer 155. FIG. 11 exemplarily illustrates a heating efficiency curve during the scanning session Ts1. The scanning session Ts1 may correspond to the time taken for the stirrer 155 to perform one rotation. That is, the scanning session Ts1 may correspond to the time taken for the stirrer 155 to rotate from an angle of zero degrees to an angle of 360 degrees.

With reference to FIG. 11, it is understood that the calculated heating efficiencies in a designated section are more than a reference heating efficiency href.

Thereafter, whether or not periodic operation for resonance mode conversion has been completed is judged (S525). That is, whether or not the periodic operation (one rotating operation) of the stirrer 155 has been completed is judged.

Upon judging that the periodic operation for resonance mode conversion has not been completed, heating efficiencies are continuously calculated while performing resonance mode conversion.

Thereafter, whether or not the heating efficiency is more than the reference heating efficiency is judged (S530), and the heating session is performed upon judging that the heating efficiency is more than the reference heating efficiency (S535). That is, power of the microwaves is increased to be greater than power of the microwaves during the scanning session, and then the microwaves of the increased power are output.

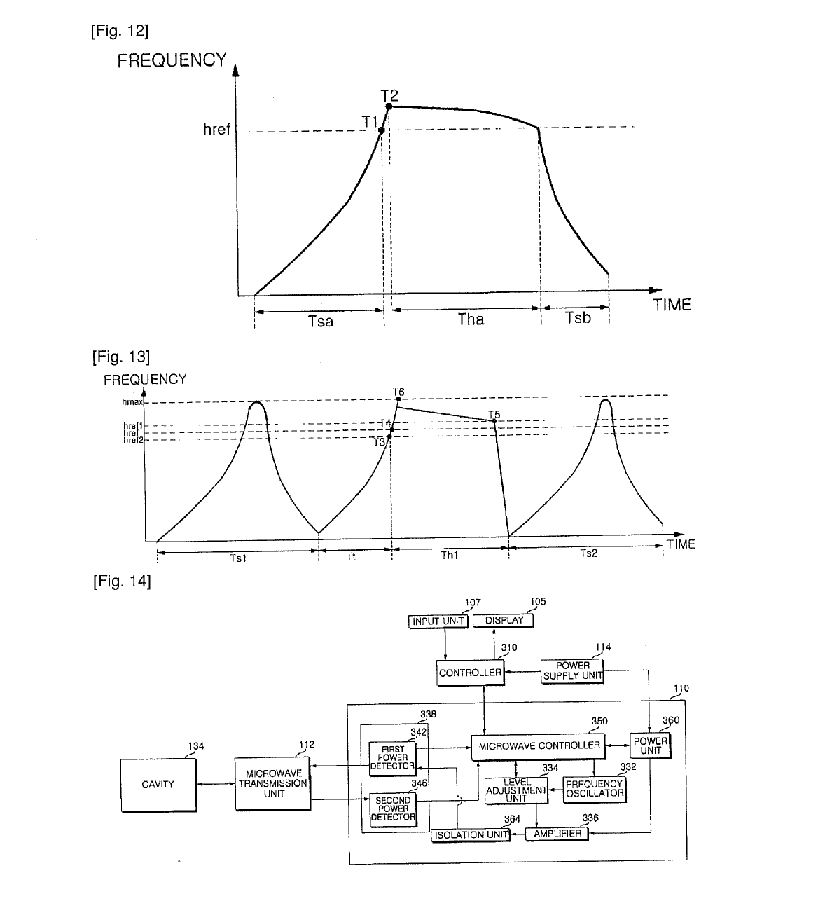

FIG. 12 exemplarily illustrates a heating efficiency curve in which heating efficiencies are calculated while operating the stirrer 155 during the scanning session Tsa, whether or not the heating efficiency is more than the reference heating efficiency href is judged, and the heating session Tha is performed upon judging that the heating efficiency is more than the reference heating efficiency href.

End time T1 of the scanning session Tsa may be set to time when the heating efficiency is the reference heating efficiency href.

Further, start time T2 of the heating session Tha may be set to time after the end time T1 of the scanning session Tsa by a designated period. However, the start time T2 of the heating session Tha may be set to the same time as the end time T1 of the scanning session Tsa.

Preferably, power of the microwaves during the heating session Tha is considerably greater than power of the microwaves during the scanning session Tsa. Thereby, heating may be effectively performed.

Further, during the heating session Tha, the controller 310 may calculate heating efficiencies. That is, after step S535, heating efficiency calculation (S520) may be performed.

If the heating efficiency calculated during the heating session Tha is less than the reference heating efficiency href or a third reference ratio to the reference heating efficiency href, the scanning session Tsa may be performed again.

Here, the stirrer 12 may be continuously rotated from a position after the heating session, as shown in FIG. 12, but is not limited thereto. That is, the stirrer 12 may be newly operated.

Upon judging that the heating efficiency is below the reference heating efficiency in step S530, resonance mode conversion (S515) and heating efficiency calculation (S525) are continuously performed.

Further, upon judging that resonance mode conversion has been completed in step S525, i.e., upon judging that the periodic operation (one rotation operation) has been completed, the maximum heating efficiency during the scanning session is calculated (S540). The controller 310 calculates the maximum heating efficiency based on the heating efficiencies calculated during the periodic operation of the resonance mode.

FIG. 13 exemplarily illustrates a heating efficiency curve in which heating efficiencies are calculated during the scanning session Ts1 while performing one rotation of the stirrer 155. Thereby, the maximum heating efficiency hmax may be calculated.

After one rotating operation of the stirrer 155 has been completed, the cooking apparatus enters a resonance mode corresponding to the maximum heating efficiency (S545). In order to enter the resonance mode corresponding to the maximum heating efficiency, the stirrer 155 is rotated to a corresponding position. Such a section may be referred to as a tracking section Tt. The traction section Tt is disposed before entry of the heating session Th1 after the scanning session Ts1 has been completed.

Thereafter, power of the microwaves is increased and then the microwaves of the increased power are output to the inside of the cavity 134 (S550). That is, the heating session Th1 is performed. Start time of the heating session Th1 may be variously set.

For example, the start time of the heating session Th1 may be time T6 corresponding to the position of the stirrer 155 corresponding to the maximum heating efficiency hmax.

Further, for example, the start time of the heating session Th1 may be operation state or operation time T3 of the stirrer 155 corresponding to a second reference ratio to the maximum heating efficiency hmax.

Further, for example, the start time of the heating session Th1 may be operation state or operation time T4 of the stirrer 155 corresponding to reference efficiencies href.

On the other hand, a designated time delay may be disposed between the start time of the heating session Th1 and the power increase section. FIG. 13 exemplarily illustrates that power of the microwaves is increased after the start time of the heating session Tha.

As described above, the heating session is started around the maximum heating efficiency hmax, thereby effectively heating an object.

Further, the end time of the heating session Th1 may be set to time when the calculated heating efficiency is less than the reference heating efficiency href or a first reference ratio href1 to the maximum heating efficiency hmax. In FIG. 13, the end time of the heating session Th1 is set to time T5 corresponding to the first reference ratio href1 to the maximum heating efficiency hmax.

Thereafter, after the heating session Th1 has been completed, the scanning session Ts2 may be performed again. Since the heating session Th1 has been performed once, the state of the object is changed, and thus, it is understood that the heating efficiency curve has been partially changed compared to the scanning session Ts1.

FIG. 14 is a block diagram briefly illustrating one example of the inside of the cooking apparatus of FIG. 1.

With reference to FIG. 14, the cooking apparatus 100 in accordance with the embodiment of the present invention includes the microwave generator 110, the microwave transmission unit 112, the cavity 134, a controller 310 and the power supply unit 114.

The microwave generator 110 includes a frequency oscillator 332, a level adjustment unit 334, an amplifier 336, a directional coupler 338, a first power detector 342, a second power detector 346, a microwave controller 350, a power unit 360 and an isolation unit 364. The microwave generator 110 implemented as the SSPA will be exemplarily described.

In the above elements, two or more elements may be combined into one element, or one element may be divided into two or more elements, as needed in actual applications.

The frequency oscillator 332 oscillates and outputs microwaves of a corresponding frequency by a frequency control signal from the microwave controller 350. The frequency oscillator 332 may include a Voltage Controlled Oscillator (VCO). The VCO oscillates the corresponding frequency according to a voltage level of the frequency control signal. For example, as the voltage level of the frequency control signal is higher, the frequency oscillated and generated by the VCO is higher.

The level adjustment unit 334 oscillates and outputs the microwaves, having been oscillated and output by the frequency signal of the frequency oscillator 332, with corresponding power according to a power control signal. The level adjustment unit 334 may include a Voltage Controlled Attenuator (VCA).

The VCA performs a compensation operation so as to output the microwaves with corresponding power according to the voltage level of the power control signal. For example, as the voltage level of the power control signal is higher, the power level of the signal output from the VCA is higher.

The amplifier 336 amplifies, based on the frequency signal oscillated by the frequency oscillator 332 and the power control signal generated by the level adjustment unit 334, the oscillated frequency signal and then outputs microwaves.

The Directional Coupler (DC) 338 transmits the microwaves amplified and output from the amplifier 336 to the microwave transmission unit 112. The microwaves output from the microwave transmission unit 112 heat the object in the cavity 134.

Microwaves, which are not absorbed by the object in the cavity 134, instead being reflected by the object, may be input to the DC 338 through the microwave transmission unit 112. The DC 338 transmits the reflected microwaves to the microwave controller 350.

The DC 338 may include the first power detector 342 to detect power of output microwaves and the second power detector 346 to detect power of reflected microwaves. The first power detector 342 and the second power detector 346 may be disposed between the DC 338 and the microwave controller 350, and be disposed on the DC 338 on a circuit.

The first power detector 342 detects output power of microwaves amplified by the amplifier 336 and transmitted to the microwave transmission unit 112 via the DC 338. The detected power signal is input to the microwave controller 350 and is used in heating efficiency calculation. The first power detector 342 may include a resistor, a Schottky diode element, etc. for power detection.

On the other hand, the second power detector 346 detects power of microwaves reflected by the inside of the cavity 134 and received by the DC 338. The detected power signal is input to the microwave controller 350 and is used in heating efficiency calculation. The second power detector 346 may include a resistor, a Schottky diode element, etc. for power detection.

The microwave controller 350 is operated by drive power supplied from the power unit 360 of the microwave generator 110. The microwave controller 350 may control operation of the elements of the microwave generator 110 in communication with the controller 310.

The microwave controller 350 calculates heating efficiencies based on microwaves, which are not absorbed by the object, instead being reflected by the object, from among the microwaves discharged to the inside of the cavity 134.

If microwaves of a plurality of frequencies are discharged to the inside of the cavity 134, the microwave controller 350 calculates heating efficiencies hₑ of the microwaves according to frequencies. Such heating efficiency calculation may be performed throughout the entire cooking session according to the embodiment of the present invention.

In order to effectively achieve heating, the entire cooking session may be divided into a scanning session and a heating session. During the scanning session, the microwaves of the plurality of frequencies are sequentially discharged to the inside of the cavity 134, and heating efficiencies are calculated based on reflected microwaves. Further, during the heating session, the microwaves are output for different output times according to frequencies or only microwaves of a designated frequency are output, based on the heating efficiencies calculated during the scanning session. Preferably, power of the microwaves during the heating session is considerably greater than power of the microwaves during the scanning session.

The microwave controller 350 generates and outputs a frequency control signal so as to vary the output times of the microwaves according to the calculated heating efficiencies. The frequency oscillator 332 oscillates a corresponding frequency according to the input frequency control signal.

The microwave controller 350 generates the frequency control signal so that, if the calculated heating efficiency hₑ is high, the output time of the corresponding microwaves becomes short. That is, while the microwaves of the plurality of frequencies are sequentially swept, output times of the microwaves of the plurality of frequencies may be varied according to the calculated heating efficiencies. That is, as the heating efficiency hₑ is higher, the corresponding output time is preferably shorter. Thereby, the microwaves may be uniformly absorbed by the object to be heated within the cavity 134 according to frequencies, and thus uniformly heat the object.

On the other hand, the microwave controller 350 may control the microwaves such that the microwaves of the corresponding frequencies are output, only if the calculated heating efficiencies hₑ according to the frequencies are more than a set reference heating efficiency. That is, microwaves of frequencies having low heating efficiencies hₑ are excluded from an actual heating time, and thereby may effectively and uniformly heat the object.

The microwave controller 350, the power unit 360, the frequency oscillator 332, the level adjustment unit 334, the amplifier 336, the DC 338, the first power detector 342 and the second power detector 346 of the above-described microwave generator 110 may be integrated into one module. That is, these elements may be disposed on a single substrate so as to be integrated into one module.

The microwave controller 350 may calculate heating efficiencies of the microwaves according to frequencies, based on microwaves, which are not absorbed by food in the cavity 134, instead being reflected by the food, from among the microwaves discharged to the inside of the cavity 134, and calculates microwaves of frequencies, the calculated heating efficiencies of which are more than the set reference heating efficiency. Further, the microwave controller 350 calculates microwave frequencies, and calculates heating times of the calculated microwave frequencies. For example, if heating efficiency is more than the set reference heating efficiency, as the heating efficiency is higher, the heating time of the microwaves of the corresponding frequency is shorter. Thereby, the object may be uniformly heated.

The microwave controller 350 may control the frequency oscillator 332 and the level adjustment unit 334 so as to output microwaves to heat the food in the cavity to the inside of the cavity 134 based on the calculated heating efficiencies. Preferably, power of microwaves output to the cavity 134 during heating is considerably greater than power of microwaves output to the cavity 134 during measurement of the heating efficiencies.

If the heating efficiency, calculated based on the microwaves reflected by the inside of the cavity 134 from among the output microwaves, is below a reference heating efficiency during the heating session, the microwave controller 350 may control the microwave generator 110 so as to stop output of the microwaves of the corresponding frequency and to output the microwaves of the next frequency. Thereby, heating may be effectively performed.

Further, the microwave controller 350 may calculate heating efficiencies of the microwaves of the plurality of frequencies, based on the microwave frequencies reflected by the inside of the cavity 134 from among the microwaves output from the amplifier 336, and set heating times of the respective microwaves during the heating session according to the calculated heating efficiencies.

For example, if, from among the microwaves of the plurality of frequencies, heating efficiency of microwaves of a first frequency is higher than heating efficiency of microwaves of a second frequency, the microwave controller 350 may set heating time of the microwaves of the first frequency to be shorter than heating time of the microwaves of the second frequency.

The microwave controller 350 may output the same power control signal for the microwaves of the respective frequencies to the microwave generator 110 during heating. Further, the level adjustment unit 334 may output a regular power level according to the input power control signal.

The power unit 360 supplies drive power to the elements of the microwave generator 110. The power unit 360 supplies drive power to the microwave controller 350 and the amplifier 336. The power unit 360 receives external power supplied from the power supply unit 114, performs regulation of the external power, and then supplies the regulated power to the inside of the microwave generator 110.

The isolation unit 364 is disposed between the amplifier 336 and the DC 338, passes microwaves amplified by the amplifier 336 if the amplified microwaves are transmitted to the cavity 134, and intercepts microwaves reflected by the inside of the cavity 134. The isolation unit 364 may include an isolator. The microwaves reflected by the inside of the cavity 134 are absorbed by a resistor in the isolation unit 364 and thus do not enter the amplifier 336. Thereby, entry of the reflected microwaves to the amplifier 336 is prevented.

The microwave transmission unit 112 transmits a plurality of microwave frequencies generated and output from the microwave generator 110 to the cavity 134. Such a microwave transmission unit 112 may include a transmission line. The transmission line may be a waveguide, a microstrip line or a coaxial cable.

In order to deliver the generated microwaves to the microwave transmission unit 112, the feeder 142 may be connected, as shown in FIG. 2.

The controller 310 controls the overall operation of the cooking apparatus 100 in response to a signal received from the input unit 107. The controller 310 may communicate with the microwave controller 350 of the microwave generator 110, thus controlling operation of the elements of the microwave generator 110. The controller 310 may control the display 105 so as to display current operation, remaining cooking time, a kind of food to be cooked, etc. of the cooking apparatus 100 to the outside.

The power supply unit 114 may include a high-voltage transformer to boost power input to the cooking apparatus 100 to a high voltage and then to supply the high voltage to the microwave generator 110, or an inverter to supply high output voltage of more than approximately 3,500V, generated through switching operation of at least one switch element, to the microwave generator 110. Further, the power supply unit 114 supplies drive voltage to the controller 310.

The block diagram of the cooking apparatus 100 shown in FIG. 14 is a block diagram in accordance with the embodiment of the present invention. The respective elements of the block diagrams may be integrated, added, or omitted according to specifications of the actually implemented cooking apparatus 100. That is, two or more elements may be combined into one element, or one element may be divided into two or more elements, as needed. Further, functions performed by respective blocks are provided to describe the embodiment of the present invention, and detailed operations or devices thereof do not limit the scope of the invention.

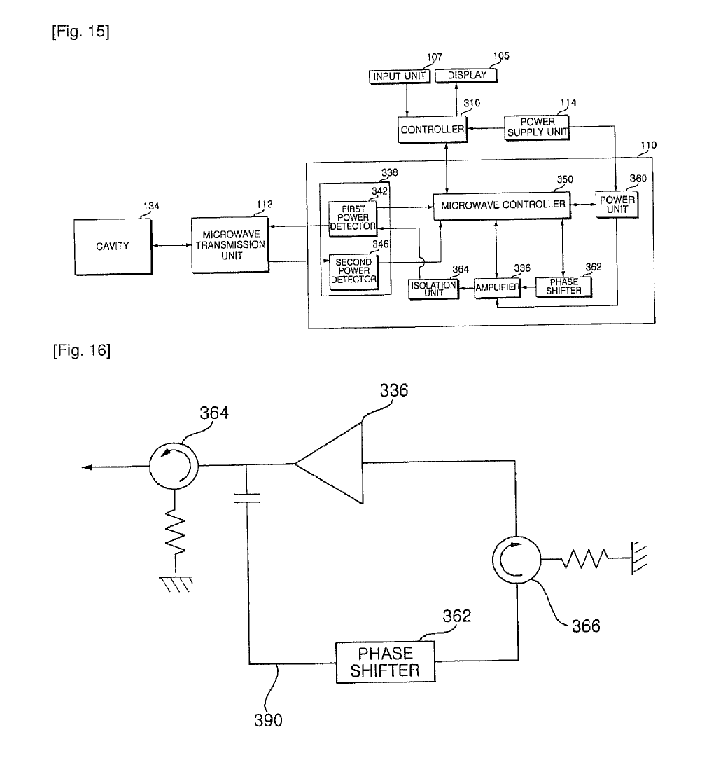

FIG. 15 is a block diagram briefly illustrating another example of the inside of the cooking apparatus of FIG. 1.

With reference to FIG. 15, differing from the microwave generator 110 of FIG. 14, the microwave generator 110 implemented as the SSPO will be exemplarily described.

A detailed description of elements of FIG. 15, which are substantially the same as those of FIG. 14, will be omitted.

In accordance with the embodiment of the present invention, the microwave generator 110 includes the microwave controller 350, the power unit 360, a phase shifter 362, the amplifier 336, the isolation unit 364 and the Directional Coupler (DC) 338.

The DC 338 may include the first power detector 342 and the second power detector 346, as described above.

The microwave generator 110 of FIG. 15 differs from the microwave generator 110 of FIG. 14 in that the microwave generator 110 of FIG. 15 excludes the frequency oscillator 322 and the level adjustment unit 334 of the microwave generator 110 of FIG. 14 and additionally includes the phase shifter 362. Therefore, differing from the microwave generator 110 of FIG. 14, the microwave controller 350 controls the amplifier 336 so as to output microwaves to heat food in the cavity 134, based on calculated heating efficiencies hₑ, to the inside of the cavity 134.

The amplifier 336 receives DC power supplied from the power supply unit 360, and performs frequency oscillation and amplification for itself. That is, the amplifier 336 performs frequency oscillation and performs amplification operation for itself based on received DC power without a separate frequency oscillator to generate and output a frequency oscillation signal.

The amplifier 336 may include at least one RF power transistor. If a plurality of RF power transistors is used, the plural RF power transistors may be connected in series, in parallel, or through combination of series connection and parallel connection so as to achieve multi-stage amplification. For example, such an amplifier 336 may be an RF power transistor. Further, output of the amplifier 336 may be approximately 100 to 1,000 W.

The phase shifter 362 may feed back output of the amplifier 336, thus achieving phase shift. A phase shift amount may be adjusted by a phase control signal of the microwave controller 350. The phase shifter 362 achieves phase shift of an amplification signal of a designated frequency output from the amplifier 336, thereby generating microwaves of various frequencies, as described above. For example, the number of frequencies may be increased in proportion to the phase shift amount.

Preferably, a signal corresponding to approximately 1% to 2% of an amplification signal level of a designated frequency is sampled and input to the phase shifter 362. This is done in consideration of re-amplification in the amplifier 336 after feedback.

Next, the isolation unit 364 re-supplies the signal, the phase of which has been shifted by the phase shifter 362, to the amplifier 336. If the level of the signal, the phase of which has been shifted by the phase shifter 362, is below a set value, the isolation unit 364 may supply the signal, the phase of which has been shifted, to a ground terminal instead of to the amplifier 336.

The signal supplied by the isolation unit 364 is re-amplified by the amplifier 336. Thereby, microwaves of a plurality of different frequencies are sequentially output.

As described above, since the amplifier 336 performs frequency oscillation and amplification for itself, the microwave generator 110 may be formed in a simple structure. Further, microwaves of a plurality of frequencies may be generated and output using the phase shifter 362.

FIG. 16 is a circuit diagram briefly illustrating the inside of the SSPO of FIG. 15.

With reference to FIG. 16, the SSPO includes the amplifier 336, the phase shifter 362, the first isolation unit 364 and a second isolation unit 366.

The amplifier 336 receives DC power from the power unit 360, and performs frequency oscillation and amplification for itself. That is, the amplifier 336 performs frequency oscillation and performs amplification operation for itself according to receipt of DC power without a separate frequency oscillator to generate and output a frequency oscillation signal.

The amplifier 336 may include at least one RF power transistor. If a plurality of RF power transistors is used, the plural RF power transistors may be connected in series, in parallel, or through combination of series connection and parallel connection so as to achieve multi-stage amplification. For example, such an amplifier 336 may be an RF power transistor. Further, output of the amplifier 336 may be approximately 100 to 1,000 W.

Next, the phase shifter 362 may feed back output of the amplifier 336, thus achieving phase shift. A phase shift amount may be adjusted by a phase control signal of the controller 310. The phase shifter 362 achieves phase shift of an amplification signal of a designated frequency output from the amplifier 336, thereby generating microwaves of various frequencies, as described above. For example, the number of frequencies may be increased in proportion to the phase shift amount.

Preferably, a signal corresponding to approximately 1% to 2% of an amplification signal level of a designated frequency is sampled and input to the phase shifter 362. This is done in consideration of re-amplification in the amplifier 336 after feedback.

The first isolation unit 364 is located between the amplifier 336 and the DC 338, passes microwaves amplified by the amplifier 336 if the amplified microwaves are transmitted to the cavity 134, and intercepts microwaves reflected by the inside of the cavity 134. The first isolation unit 364 may include an isolator. The microwaves reflected by the inside of the cavity 134 are absorbed by a resistor in the first isolation unit 364 and thus do not enter the amplifier 336. Thereby, entry of the reflected microwaves to the amplifier 336 is prevented. In more detail, the first isolation unit 364 supplies the amplified microwaves to the microwave transmission unit 112 via the DC 338. If a signal level of the microwaves supplied from the amplifier 336 is below a set value, the first isolation unit 364 may supply the microwaves to a ground terminal instead of to the microwave transmission unit 112.

Next, the second isolation unit 366 re-supplies the signal, the phase of which has been shifted by the phase shifter 362, to the amplifier 336. If the level of the signal, the phase of which has been shifted by the phase shifter 362, is below a set value, the second isolation unit 366 may supply the signal, the phase of which has been shifted, to a ground terminal instead of to the amplifier 336.

The signal supplied by the second isolation unit 366 is re-amplified by the amplifier 336. Thereby, microwaves of a plurality of different frequencies are sequentially output.

A feedback transmission line 390 serves to connect the output terminal of the amplifier 336 to the phase shifter 362. The phase shifter 362 is located on the feedback transmission line 390, and may include impedance elements, such as a switch and/or a diode.

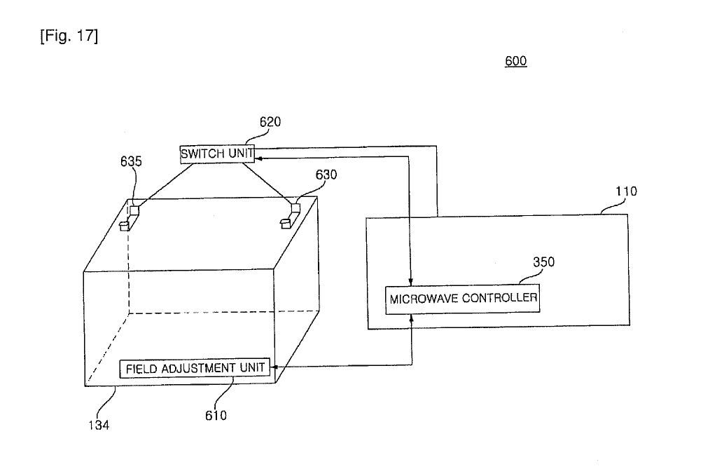

FIG. 17 is a block diagram illustrating a configuration of a cooking apparatus in accordance with another embodiment of the present invention.

A cooking apparatus 600 in accordance with this embodiment includes a cavity 134, a microwave generator 110, a microwave controller 350, a field adjustment unit 610, a switch unit 620, a first antenna 630 and a second antenna 635.

The field adjustment unit 610 may include a stirrer, a Field Adjustment Element (FAE), etc. The field adjustment unit 610 serves both to agitate microwaves radiated from antennas 630 and 635 and is coupled by the microwaves radiated from the antennas 630 and 635, and then to secondarily achieve radiation of the microwaves.

That is, some of the microwaves radiated from the antennas 630 and 635 are directly absorbed by an object to be cooked, and generate vertical temperature variation in heating within the cavity 134. The field adjustment unit 610 prevents the agitated and radiated microwaves from being directly absorbed by the object to be cooked and generates a resonance mode in the cavity 134, thereby reducing the vertical temperature variation in heating within the cavity 134 and thus uniformly heating the object to be cooked.

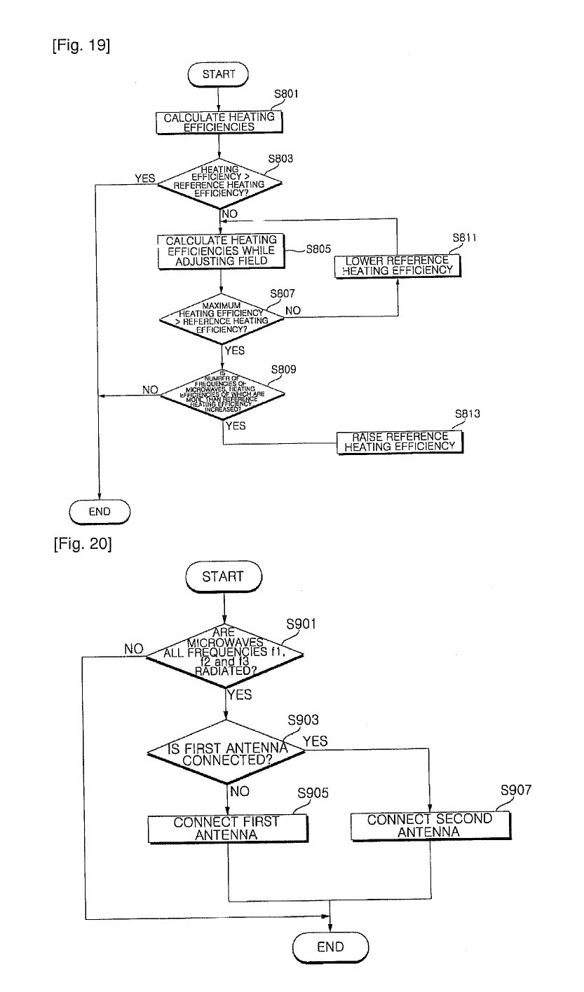

Operation of the field adjustment unit 610 will be described later with reference to FIG. 19.

The switch unit 620 serves to adjust connection between the microwave generator 110 and any one of the antennas 630 and 635. Connection of both antennas 630 and 635 is impossible, and since loads seen from the first antenna 630 and the second antenna 635 are different, microwaves radiated from the respective antennas 630 and 635 are different.

If microwaves are repeatedly radiated by the designated number of times through the first antenna 630, the switch unit 620 may replace the first antenna 630 with the second antenna 635 so that the object to be cooked is heated through the second antenna so as to uniformly heat the object.

That is, the switch unit 620 divides transmission of microwaves into a plurality of paths. The microwave transmission unit 112 may include a waveguide or a coaxial cable. The first antenna 630 and the second antenna 635 may be respectively connected to ends of the microwave transmission unit 112.

A heating amount through the first antenna 630 and a heating amount through the second antenna 635 are added through antenna replacement, thereby more uniformly heating a load.

Operation of the switch unit 620 will be described later with reference to FIG. 20.

The first antenna 630 and the second antenna 635 radiate the microwaves generated by the microwave generator 110 to the inside of the cavity 134.

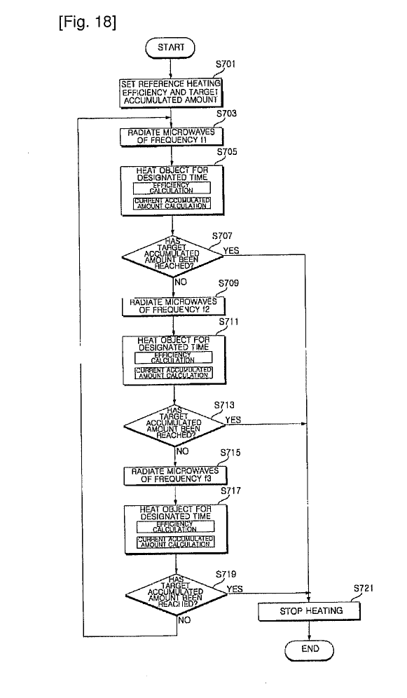

FIG. 18 is a flow chart illustrating an operating method of the cooking apparatus in accordance with the embodiment of the present invention.

The controller 310 may control the overall operation of the cooking apparatus and set a reference heating efficiency for microwave radiation and a target accumulated amount. The reference heating efficiency and the target accumulated amount set by the controller 310 are transmitted to the microwave controller 350, and operation of the microwave generator 110 is started (S701).

The microwave generator 110 radiates microwaves having one frequency f1 from among microwaves of discontinuous frequencies (S703).

The radiated microwaves heat an object to be cooked using moisture in the object, and the microwave controller 350 calculates heating efficiency under the current environment in the cavity 134 in the middle of heating of the object. Further, the microwave controller 350 calculates an accumulated amount according to a heating degree (S705).

The microwave controller 350 judges whether or not the target accumulated amount has been reached by comparing the current accumulated amount with the set target accumulated amount (S707).

Upon judging that the target accumulated amount has been reached, the microwave controller 350 stops heating of the object (S721), and upon judging that the target accumulated amount has not been reached, the microwave controller 350 radiates microwaves having another frequency f2 differing from the former frequency f1 from among the microwaves of the discontinuous frequencies (S709).

The microwave controller 350 heats the object to be cooked for a designated time for the radiated microwaves having the frequency f2. In the middle of heating of the object, the microwave controller 350 calculates heating efficiency under the current environment in the cavity 134, and calculates an accumulated amount according to a heating degree (S711).

Thereafter, the microwave controller 350 judges whether or not the target accumulated amount has been reached by comparing the current accumulated amount with the set target accumulated amount (S713).

Upon judging that the target accumulated amount has been reached, the microwave controller 350 stops heating of the object (S721), and upon judging that the target accumulated amount has not been reached, the microwave controller 350 radiates microwaves having another frequency f3 differing from the former frequency f2 from among the microwaves of the discontinuous frequencies (S715).

The microwave controller 350 heats heat the object to be cooked for a designated time using the radiated microwaves having the frequency f3. In the middle of heating of the object, the microwave controller 350 calculates heating efficiency under the current environment in the cavity 134, and calculates an accumulated amount according to a heating degree (S717).

Upon judging that the target accumulated amount has been reached (S719), the microwave controller 350 stops heating of the object (S721), and upon judging that the target accumulated amount has not been reached, the microwave controller 350 again radiates the microwaves having the frequency f1 which has been firstly radiated (S703). Such a process is repeated.

While the above process is repeated, if the target accumulated amount has been reached, the microwave controller 350 stops heating of the object to be cooked.

FIG. 19 is a flow chart illustrating a process of calculating heating efficiencies.

In FIG. 18, in Operations S705, S711 and S717, while heating of the object to be cooked is carried out for a designated time, heating efficiency is calculated. FIG. 19 is a flow chart illustrating such heating efficiency calculation.

The microwave controller 350 calculates heating efficiencies based on microwaves reflected by the inside of the cavity 134 from among microwaves output to the inside of the cavity 134 (S801). Equation relating to a heating efficiency calculation method has been described above.

The microwave controller 350 compares the calculated heating efficiency with set reference heating efficiency (S803). If the calculated heating efficiency exceeds the set reference heating efficiency, the microwave controller 350 heats the object using microwaves the corresponding frequency without control of the field adjustment unit 610, and judges whether or not the target accumulated amount has been reached when the object is heated using the microwaves having the corresponding frequency.

If the calculated heating efficiency is below the set reference heating efficiency, the microwave controller 350 rotates the field adjustment unit 610 and thus adjusts a field. The microwave controller 350 continuously calculates heating efficiencies while adjusting the field, so that a resonance mode, the frequency of which has the calculated heating efficiency exceeding the reference heating efficiency, is formed (S805).

The microwave controller 350 judges whether or not the maximum heating efficiency of radiated microwaves exceeds the reference heating efficiency through operation of the field adjustment unit 610 (S807).

If the maximum heating efficiency of radiated microwaves does not exceed the reference heating efficiency even through operation of the field adjustment unit 610, the microwave controller 350 lowers the reference heating efficiency (S811). For example, the reference heating efficiency may be lowered by approximately 2%.

For example, if microwaves having a frequency, heating efficiency of which exceeds a first critical value A, are not present at the critical value A, microwaves having respective frequencies corresponding to a second critical value C, which is lower than the maximum heating efficiency B from among the calculated heating efficiencies by a set value, are selected and then used in heating.

On the other hand, if the maximum heating efficiency of radiated microwaves exceeds the reference heating efficiency through operation of the field adjustment unit 610, the microwave controller 350 judges the number of frequencies having heating efficiencies exceeding the reference heating efficiency (S809). If the number of frequencies having heating efficiencies exceeding the reference heating efficiency after operation of the field adjustment unit 610 is greater than the number of frequencies having heating efficiencies exceeding the reference heating efficiency prior to operation of the field adjustment unit 610, the microwave controller 350 may raise the reference heating efficiency. For example, the reference heating efficiency may be raised by approximately 2%.

The raising of the reference heating efficiency is done to more uniformly heat the object, to reduce energy consumption and to shorten heating time, if microwaves having a frequency having heating efficiency exceeding the reference heating efficiency are used to heat the object.

Shortening of heating time means that the target accumulated amount may be more rapidly reached.

FIG. 20 is a flow chart illustrating operation of the switch unit in the cooking apparatus in accordance with the embodiment of present invention.

The number of discrete frequencies which may be output may be varied according to the type of the phase shifter 362. Hereinafter, the cooking apparatus which outputs three discrete frequencies f1, f2 and f3 to be used in heating will be exemplarily described.

The switch unit 620 may be an RF switch, as described above, and divides transmission of microwaves into a plurality of paths. That is, the switch unit 620 decides through which one of the antennas 630 and 635 microwaves generated by the microwave generator 110 are radiated to the inside of the cavity 134. Further, if the plural antennas 630 and 635 are provided, plural microwave transmission units connected to the plural antenna 630 and 635 may be provided. That is, plural microwave transmission units 112 to respectively transmit microwaves divided by the switch unit 620 to the first antenna 630 and the second antenna 635 may be provided.

If microwaves of all the frequencies f1, f2 and f3 generated by the microwave generator 110 are radiated through the first antenna 630 (S901), a process of switching connection between the antenna 630 or 635 and the microwave generator 110 is started.

For example, if the microwaves of all of the three frequencies f1, f2 and f3, which may be generated by the microwave generator 110, are radiated one time, the microwave controller 350 judges whether or not the first antenna 630 is connected to the microwave generator 110 (S903).

Upon judging that the first antenna 630 is connected to the microwave generator 110, the microwave controller 350 changes connection between the first antenna 630 and the microwave generator 110 into connection between the second antenna 635 and the microwave generator 110.

The antennas 630 and 635 disposed at different positions are used, and thus heating efficiencies of microwaves radiated from the respective positions are varied. Therefore, if the target accumulated amount has not been reached through radiation of the microwaves of all frequencies through the first antenna 630, the antenna to radiate microwaves is switched from the first antenna 630 to the second antenna 635. Thereby, heating efficiencies may be increased.

The above-described various control operations as performed by the microwave controller 350 may be performed by the controller 310. That is, the controller 310 may control the switch unit 620 such that the second antenna 635 is connected to the microwave generator 110, if microwaves are repeatedly radiated by the designated number of times to the inside of the cavity 134 through the first antenna 630.

Further, the controller 310 may calculate heating efficiencies based on microwaves reflected by the inside of the cavity 134 from among microwaves output to the inside of the cavity 134.

Further, the controller 310 may rotate the field adjustment unit 610, if the calculated heating efficiency is below than the reference heating efficiency.

Further, the controller 310 may lower the reference heating efficiency, if the calculated heating efficiency is below the reference heating efficiency.

Further, the controller 310 may calculate heating efficiencies according to frequencies using the microwaves reflected by the inside of the cavity from among the microwaves output to the inside of the cavity 134, and control the microwave generator 110 so as to generate microwaves of designated frequencies based on the calculated heating efficiencies.

Although the embodiment of the present invention describes the cooking apparatus using microwaves, the present invention is not limited thereto and the cooking apparatus using microwaves may be combined with various cooking apparatuses. As one example, the cooking apparatus using microwaves in accordance with the embodiment of the present invention may be combined with an oven-type cooking apparatus using a heater as a heating source. Further, as another example, the cooking apparatus using microwaves in accordance with the embodiment of the present invention may be combined with a cooking apparatus using an induction heater as a heating source. Further, as a further example, the cooking apparatus using microwaves in accordance with the embodiment of the present invention may be combined with a cooking apparatus using a magnetron as a heating source.

The cooking apparatus in accordance with the present invention is not limited to configurations and methods of the above-described embodiments, and all or some of the respective embodiments may be selectively combined so as to achieve various modifications.

Effects of the present invention are not limited to the above-stated effects, and those skilled in the art will understand other effects, which are not stated above, from the accompanying claims.

Although the embodiments of the present invention have been disclosed for illustrative purposes, those skilled in the art will appreciate that various modifications and applications are possible, without departing from the scope and spirit of the invention as disclosed in the accompanying claims. For example, the respective elements described in detail in the embodiments may be modified. Further, it will be understood that differences relating to such modifications and applications are within the scope of the invention defined in the accompanying claims.

### INDUSTRIAL APPLICABILITY

The present invention is applied to a cooking apparatus using microwaves.

1. A cooking apparatus comprising:
a microwave generator to generate and output microwaves of a plurality of frequencies to heat an object within a cavity;
a resonance mode conversion unit to convert a resonance mode by varying at least one of progressing direction, power or frequency of the microwaves output to the inside of the cavity; and
a controller to operate the resonance mode conversion unit, if the number of frequencies of microwaves, the heating efficiencies of which are more than a reference heating efficiency, is below a reference value, based on heating efficiencies calculated according to microwaves reflected by the inside of the cavity from among the output microwaves.

2. The cooking apparatus according to claim 1, wherein the controller performs second operation of the resonance mode conversion unit, if the number of frequencies of microwaves, the heating efficiencies of which are more than the reference heating efficiency, is below the reference value, based on the heating efficiencies calculated according to the microwaves reflected by the inside of the cavity from among the output microwaves, after first operation of the resonance mode conversion unit.

3. The cooking apparatus according to claim 1, wherein the controller lowers the reference heating efficiency, if the number of frequencies of microwaves, the heating efficiencies of which are more than the reference heating efficiency, is below the reference value, based on the heating efficiencies calculated according to the microwaves reflected by the inside of the cavity from among the output microwaves, after periodic operation of the resonance mode conversion unit has been completed.

4. The cooking apparatus according to claim 3, wherein the controller performs a heating session using microwaves of corresponding frequencies, if the number of frequencies of microwaves, the heating efficiencies of which are more than the lowered reference heating efficiency, is more than the reference value.

5. The cooking apparatus according to claim 3, wherein the controller raises the lowered reference heating efficiency, if the number of frequencies of microwaves, the heating efficiencies of which are more than the lowered reference heating efficiency, is more than the reference value based on the calculated heating efficiencies.

6. The cooking apparatus according to claim 1, wherein the resonance mode conversion unit includes at least one of a stirrer, a rotating table or a sliding table.

7. The cooking apparatus according to claim 6, wherein, if the resonance mode conversion unit includes the stirrer, the controller rotates the stirrer, and calculates the heating efficiencies according to the microwaves reflected by the inside of the cavity from among the output microwaves, after rotation of the stirrer by a first angle.

8. A cooking apparatus comprising:
a microwave generator to generate and output microwaves of a single frequency to heat an object within a cavity;
a resonance mode conversion unit to convert a resonance mode by varying at least one of progressing direction, power or frequency of the microwaves output to the inside of the cavity; and
a controller to calculate heating efficiencies according to microwaves reflected by the inside of the cavity from among the output microwaves during operation of the resonance mode conversion unit, to calculate the maximum heating efficiency based on the calculated heating efficiencies after operation of the resonance mode conversion unit has been completed, and to perform a heating session according to an operation state of the resonance mode conversion unit corresponding to the calculated maximum heating efficiency.

9. The cooking apparatus according to claim 8, wherein the controller, during the heating session, controls the resonance mode conversion unit so as to enter the operation state or an operation time corresponding to the maximum heating efficiency, and increases power of the microwaves to be greater than power of microwaves during calculation of the heating efficiencies.

10. The cooking apparatus according to claim 8, wherein the controller, during the heating session, operates the resonance mode conversion unit so as to calculate again heating efficiencies, if heating time is more than a designated time or if the heating efficiency is less than a first reference ratio to the maximum heating efficiency.

11. The cooking apparatus according to claim 8, wherein the controller, during the heating session, controls the resonance mode conversion unit so as to enter an operation state or an operation time corresponding to a second reference ratio to the maximum heating efficiency, and increases power of the microwaves to be greater than power of microwaves during calculation of the heating efficiencies.

12. A cooking apparatus comprising:
a microwave generator to generate and output microwaves of a single frequency to heat an object within a cavity;
a resonance mode conversion unit to convert a resonance mode by varying at least one of progressing direction, power or frequency of the microwaves output to the inside of the cavity; and
a controller to calculate heating efficiencies according to microwaves reflected by the inside of the cavity during operation of the resonance mode conversion unit, and to stop operation of the resonance mode conversion unit and to perform a heating session, if the calculated heating efficiency is more than a reference heating efficiency.

13. The cooking apparatus according to claim 12, wherein the resonance mode conversion unit includes at least one of a stirrer, a rotating table and a sliding table.

14. The cooking apparatus according to claim 13, wherein, if the resonance mode conversion unit includes the stirrer, the controller rotates the stirrer one time, and calculates the heating efficiencies according to microwaves reflected by the inside of the cavity from among microwaves output during one rotation of the stirrer.

15. A cooking apparatus using microwaves comprising:
a cavity;
a microwave generator to generate and output microwaves to the inside of the cavity;
a field adjustment unit to adjust frequencies of the microwaves output from the microwave generator;
an antenna unit located within the cavity to irradiate the microwaves output from the microwave generator to the inside of the cavity; and
a switch unit to divide transmission paths of the microwaves output from the microwave generator,
wherein the microwave generator includes a microwave controller to control the field adjustment unit and the switch unit so as to adjust the frequencies, and a power unit to supply drive power of the microwaves.

16. The cooking apparatus according to claim 15, wherein the antenna unit includes a first antenna and a second antenna disposed at different positions.

17. The cooking apparatus according to claim 16, wherein the microwave controller controls the switch unit so as to connect the second antenna to the microwave generator, if the microwaves are repeatedly radiated by the designated number of times to the inside of the cavity through the first antenna.

18. The cooking apparatus according to claim 16, further comprising a plurality of microwave transmission units to respectively transmit microwaves divided by the switch unit to the first antenna and the second antenna.

19. The cooking apparatus according to claim 15, wherein the microwave controller calculates heating efficiencies based on microwaves reflected by the inside of the cavity from among the microwaves output to the inside of the cavity, and rotates the field adjustment unit, if the calculated heating efficiency is below a reference heating efficiency.

20. The cooking apparatus according to claim 15, wherein the microwave controller calculates heating efficiencies based on microwaves reflected by the inside of the cavity from among the microwaves output to the inside of the cavity, and lowers a reference heating efficiency, if the calculated heating efficiency is below the reference heating efficiency.
